(19) United States
(12) Patent Application Publication
(10) Pub. No.: US 2011/0010291 A1
(43) Pub. Date: Jan. 13, 2011

(54) Paperless Transaction Trail System

(76) Inventor: Mark W. Adams, San Jose, CA (US)

Correspondence Address: IPLO-Intellectual Property Law Offices, 95 SOUTH MARKET STREET SUITE 570, San Jose, CA, 95113, US

(21) Appl. No.: 12/665,660

(22) PCT Filed: Jun. 23, 2008
(86) PCT No.: PCT/US08/07921

§ 371 Date: Dec. 18, 2009

Related U.S. Application Data
(63) Continuation of application No. 60/945,909, filed on Jun. 23, 2007.

(51) Int. Cl. G06Q 40/00

(52) U.S. Cl. 705/39

(57) ABSTRACT

A paperless transaction system (10) is provided for use as a universal customer interface utilized to engage in purchase and financial transactions (11). The system (10) includes an institutional subsystem (12) and a consumer subsystem (14) which interact through dataports (30), either physical or wireless. The consumer subsystem includes a user-carried dongle (74) having a memory component (76) for storing relevant information (50, 52, 54). Engaging dongle (74) with a TIST (22) of the institution acts to disable printers (26) and instead generates an electronic transaction record (38) stored in the dongle (74). Security is provided by a PIN (58) or biological identifier device (62) specific to the user.

This application claims priority from PCT Application No. PCT/US 08/07921 filed 23 Jun. 2008, designating the US as one of the states, which in turn claims priority from the U.S. provisional application of the same general title, filed on 23 Jun. 2007 as application No. 60/945,909.

### TECHNICAL FIELD

The present invention relates generally to electronic transaction devices, whether direct or wireless, and particularly to ATM machines, cash registers and remote electronic transaction systems (Internet) and to consumer personal devices for interfacing therewith.

### BACKGROUND ART

A great deal of paper is wasted every day by consumers engaging in transactions, be they purchases at the grocery store, deposits or withdrawals at the bank or numerous other financial transactions. In nearly every transaction, a paper receipt is printed and provided to the customer/client at the end. Although these are occasionally useful for immediate review or for purposes of showing purchase information to exit security guards, this is infrequently the case. In most cases the receipt, often half a meter or greater in length, is simply glanced at and discarded into the nearest trash bin, rarely even into recycling bins. This results in a great deal of waste disposal and unnecessary printing and paper costs.

In most cases, the transactions are handled and recorded by computers or computer powered devices such as automated teller machines (ATMs) or cash registers. These devices frequently download information on the transaction into databases, which may in some limited circumstances cases be accessed by the consumer. However, electronic records of most transactions are not available, at least in any detail, to the user.

The development of debit/credit cards which may be swiped for speedy transactions has resulted in a demand for increasing the fluidity and speed of purchasing. However, such methods have disadvantages in terms of security (anyone can use the card) and do nothing to address the paper reduction or transaction recording issues.

Online and wireless transactions are often hampered by the cumbersome and marginally effective procedures necessary to provide consumer credit information. It is not desirable for the consumer to provide each online merchant or service provider with sensitive information over the internet, but it is inconvenient to avoid this while providing for purchase transactions.

Accordingly, it is highly desirable to provide electronic data reflecting the content of transactions to the consumer. Further, any way to minimize the immense cost of paper and printing materials and technology would be a great benefit to both the consumer and the institution, not to mention the environment. Additionally, there is a continuing need to provide increased rapidity of transactions and security of sensitive user information. There is thus a great need and desire for methods to streamline transaction recording and availability to the consumer while reducing cost to the providers.

### DISCLOSURE OF INVENTION

Accordingly, it is an object of the present invention to provide a method for providing transaction information to consumers without using paper tallies.

Another object of the invention is to make electronic transaction information available to the user simultaneously with transaction.

A further object of the present invention is to allow a user to easily access and use transaction information sorted by institution and date.

Yet another object of one embodiment of the present invention is to provide an interactive record of transactions, which can interact with the institutional records when it is necessary to revisit transactions.

A further object of the present invention is to provide transaction records stored in a user-carried dongle, which records may be transferred to and merged with other accounting records of the user

An additional object of the present invention is to provide a system which allows the user to avoid carrying numerous “vendor cards” by having the electronic card information stored on a user carried electronic device, a dongle such as a PMD (Personal Memory Device), (UCIM) Universal Customer Interface Module or an ISIM (Issuer Specific Interface Module).

Still another object of the present invention is to provide a consumer subsystem which is entirely personal to a single consumer, with security activation built in, whether by PIN identification, thumbprint activation, biologically specific user input or the like.

Yet another object of the invention is to provide system wherein the institution may access membership information and credit information from a single source; minimizing transaction steps.

Another object of the present invention is provide a method of creating and storing meta records of each transaction, with identical copies existing in the institutional memory and the user's device memory.

A further object of the invention is to provide a system where transactions may be permitted to only go forward after each participant accepts the other's identification as valid.

Briefly, one preferred embodiment of the present invention is a device, system and method for electronically providing transaction information to a consumer/user in a contemporaneous manner. Institutions having transaction information supply terminals (TIST) such as cash registers and ATMs will provide dataports (typically USB ports or wireless interface) on a transaction device, such as a cash register or ATM, into which a user may interface (insert) a personal memory device (PMD), such as memory stick, thumb drive or the like, to electronically receive and store data. At the end of each transaction the transaction details, keyed to the institution and date, will be transferred from the transaction device to the personal storage unit. The user may then transfer records periodically to a personal computer or similar device programmed to receive, store and manipulate the data for accounting and management purposes.

The components of the overall system of the preferred embodiment are an institutional transaction device provided with an external, consumer accessible dataport, the transaction device being programmed to download receipt and other transaction data via the data port. The user will have a personal memory device (PMD) compatible with the dataport. The user mates the PMD with the dataport and, at the close of the transaction, a discreet data packet is downloaded to the PMD including all of the transaction details, and being keyed to the institution and the transaction date and time. The data packets can be downloaded from the PMD into the user's personal computing equipment and printed or displayed as necessary for review. Optimally, the user may have software available to receive the data packets and utilize these for detailed reporting, collation and manipulation into usable reports and categorizations.

A deluxe version allows the institutional TIST to have limited two-way communication with an enhanced version of the PMD referred to as a Universal Consumer Interface Module (UCIM), exchanging recognition information, vendor membership information, credit and financial information and the like. The two-way capability is triggered only after security activation by the consumer, such as by use of a PIN or a biogenic key. The deluxe version permits high speed electronic communications during the transaction and facilitates rapid processing.

A further embodiment of the invention involves a universal customer interface with a self authenticating UCIM referred to as a dongle which may be used either with onsite dataport or with wireless or internet communications for secure and rapid transactions. The dongle may be in the form of an Issuer Specific Interface Module (ISIM) which is uniquely associated with both an Issuer and a particular User.

An advantage of the present invention is that it may be used to store the user's personal information, such as for vendor cards, ATM cards, credit cards and the like which may be directly accessed by the transaction device, thus eliminating the need for carrying multiple cards.

Another advantage of the invention is that it can be provided with internal security such that an institution may only retrieve information matching its own code which has been previously downloaded into the PMD, UCIM or ISIM, such as receipts from prior transactions, vendor cards and the like.

An additional advantage of the invention is that personal security may be built into the PMD, UCIM or ISIM such that only the intended user will be able to activate the dongle in use, with the personal security options including PIN activation and physical or biogenic activation, such as by thumbprint.

A further advantage of the invention is that it helps save the environment by eliminating a significant source of waste for disposal, that being the numerous printed transaction receipts.

Yet another advantage of the present inventive system is that user dongles may be customized by credit issuers, banks and the like and may be made personal to each user, so that only that user can activate certain feature.

Still another advantage of the invention is that self-authenticating dongles can be utilized in merchant transactions which are very fast and which are much more secure than those using conventional debit cards, since only the authenticated user can make the dongle function.

Another advantage of the present invention is that self-authenticating dongles using encrypted communications with credit authorization institutions can significantly improve the convenience and safety of online transactions.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

FIG. 1 is a diagrammatical view of a Universal Customer Interface embodiment of the inventive system, particularly illustrating the components;

FIG. 2. is a diagrammatical view of a Universal Customer Interface embodiment of the inventive system, particularly illustrating the connections and relationships among the components; and

FIG. 3 is a diagrammatical view of the components of the UCI dongle of the inventive system.

### BEST MODE FOR CARRYING OUT THE INVENTION

The present invention is a system for carrying out paperless transactions 10 and is adapted for use in a commercial type transaction 11 between a consumer and an institution. The overall system is designated by the general reference character 10 and includes two component subsystems. An institutional subsystem 12 includes all of the components on the part of the institution (vendor, store, online merchant, online service provider, bank or the like) while a consumer subsystem 14 includes all of the components used by the consumer. Both subsystems 12 and 14 are necessary and work in combination for effective usage.

A simplified system 16 is envisioned where the intention is to simply record and retrieve transaction data while avoiding the use of paper. This will involve merely recordation of generally non-sensitive transaction information and will not involve extensive security precautions. A deluxe system 18 is also envisioned which involves a great deal more personal and sensitive information and two-way communications, thus requiring additional security precautions. Both simplified system 16 and deluxe system 18 involve similar components and operations and they share the basic functions.

In each case the institutional subsystem 12 will include a transaction device 20 such as a cash register, ATM or the like. The transaction device is ordinarily a transaction information supply terminal (TIST) 22 which is typically a moderately sophisticated data processing system programmed to interact with the consumer (and sometimes with institutional personnel, such as cashiers). The TIST 22 will be provided with consumer input structures 24 which may include a keypad, a card reader, bar code scanner, biological interface devices (such as fingerprint or thumbprint readers and, in embodiments envisioned for the future, DNA comparison components), voice activated devices, or even direct interface with live personnel. The TIST 22 will also (at least in past embodiments) include a printer 26 for providing a transaction record (receipt or tally) 28 for delivery to the consumer at the end of the transaction. The transaction record 28 is useful for memorializing the transaction and for occasional use, such as when a return of an item is made to the institution or for the purposes of correcting a discrepancy. In the past, these transaction tallies 28 were usually discarded very quickly, thus adding to the volume of paper trash affecting the embodiment. In some instances, of course, the consumer would instead retain the paper tally 28 in a shoebox or the like for accounting and tax purposes.

A feature of the present invention 10 is that the institutional subsystem 12 is provided with a consumer accessible dataport 30. In technology which is current as of the writing of this patent application, the dataport 30 is envisioned to be a USB port 32, although numerous other types of dataports 30 are currently envisioned and many more will undoubtedly be utilized in the future. Envisioned varieties of dataports 30 include wireless interfaces such as RFI scanners, optical interfaces, ultrasound interfaces, and Bluetooth, all of which are capable of delivering and exchanging information between two components. The dataport 30 is adapted to interface with a personal memory device (PMD) 34 carried by, and personal to, the consumer.

The TIST 22 is provided with a printer interrupt 36 which will activate whenever a PMD 34 is engaged with the dataport 30. This will, unless overridden by input from the consumer or institutional personnel, cause the transaction report 28 to be delivered only to the PMD 34 and not to the printer 26. In this manner paper and ink are saved whenever a consumer uses a PMD with the system 10.

The transaction report 28 delivered from the TIST 22 to a PMD 34 is not the same as a printed receipt in all particulars. Instead, it is in the form of an electronic transaction record (ETR) 38. Each ETR 38 will include particular electronic coding to uniquely identify the particular transaction and tag the electronic packet in a way that it can be recognized, separated from and sorted in relation to other transactions. The coding will include an institutional ID 40 specifying the particular institution and location of the TIST 22. There will also be date and time coding 42 as part of a packet header. In addition, each individual transaction entry 44 in the transaction 11 (such as separate items purchased at a grocery store) may include an electronic item ID 46 such as a bar code or other inventory identifier associated with the item by the institution.

The ETR 38 is adapted to be printed out by the user in conjunction with other software available to the consumer, in the event that a paper record is needed for some purpose. In addition the ETR 38 is adapted to interface with recordkeeping software, such as personal financial accounting programs which may be used to parse and analyze the transactions. The PMD 34 is fully compatible with other machines having the same sort of dataport 30 (especially in the case of a USB port 32) and the consumer uses are virtually unlimited. Of course, it is also possible to recreate the ETR 38 for dealing with the particular institution, such as when returning merchandise. In the simplified system 16 embodiment, the institution may have an available processor 46 separate from the TIST 22 (such as at a Customer Service counter) which will also have a dataport 30, so the same effect as a paper receipt can be duplicated. In the deluxe system 18 embodiment, the TIST 22 itself may have two-way communication ability and the ETR 38, along with other information on the PMD 34 may (depending on the degree of access permitted by the associated software) be accessed by the TIST 22 for use.

The simplified embodiment 16 described above is sufficient for a primary purpose of the invention, that being the ability to minimize paper and ink expenditures resulting from commonplace transactions. This alone would be a great benefit to institutions and society as a whole. For such implementations the ordinary sort of commonly commercially available (relatively passive and inexpensive) PMD devices, commonly known as “thumb drives” or USB memory devices are entirely sufficient, since the only purposes are to provide memory storage for the ETR 38 and to activate the dataport communications. However, numerous other purposes may be accomplished by the deluxe system 18 embodiment, with enhanced software and greater two-way communication between the PMD 34 and the TIST 22. In such cases, a functionally enhanced PMD 34, referred to as a Universal Customer Interface Module (UCIM) 47 is utilized with enhanced memory and logic to facilitate interactive two-way communication with the TIST 22.

In the deluxe system embodiment 18 the TIST 22 is enabled to draw information from the UCIM 47 directly. Thus, the TIST 22 is provided with upload capacity 48. The upload features of the TIST 22 may be activated either by specific encoding in the particular packets or by consumer triggering using the consumer input 24 features. In either of these methods the institution may (depending on the particular software) be authorized and enabled to access some limited amount of personal data from the UCIM 47.

The consumer will be able, in the deluxe system embodiments 18, to store significant personal information on the UCIM 47. This will be carried in discreet packets corresponding to different types of data. Typical information will include personal ID information 50, vendor membership information 52, credit and financial information 54 and the like. The personal ID information 52 may include driver's license numbers, address and telephone and other specific information which may be necessary to transactions. Vendor membership information 52 will be the same that typically carried on cards specific to a particular vendor, such as purchasing clubs, discount cards and the like which are keyed to the store, health club or the like. By placing the vendor membership information 52 on the UCIM 47 the consumer save wallet or purse space and increases convenience. The credit/financial information 54 will be information typically carried on individual credit cards or bank ATM cards. As will be discussed in more detail hereinafter, the particular UCIM 47 utilized in some cases may be a Issuer Specific Interface Module (ISIM) 55 associated with a particular credit issuer of bank and carrying greater details particular to the accounts between the user and that issuer.

The personal ID information 50 will ordinarily not be particularly sensitive. Therefore, it is envisioned that special security encoding will not be necessary, as this will be the same sort of things ordinarily found on ID cards or the like used in verifying transactions. Accordingly, this will ordinarily be transparent to the TIST 22. However, it may be desirable to make this accessible only when manually triggered by the consumer, in order to protect privacy when desired.

The vendor membership information 52 will be semitransparent in most cases. That is, each item in the vendor info 52 will be specifically tagged with encoding particular to the vendor. That is, each store or institution will have particular coding corresponding to its own membership identifiers and the TIST 22 will be programmed to access only such information corresponding to the particular information. In this manner, the UCIM 47 will be inserted into the dataport 30 and the membership will be immediately recognized by the corresponding TIST 22, providing building access and discounts on purchases, or whatever other benefits are involved, all in a single step. The typical UCIM 47 will include multiple vendor membership packets corresponding to all of the particular groups to which the individual consumer subscribes. The information can be loaded on the UCIM 47 either directly from the institutional TIST 22 at time of sign-up or from the consumer's own computer. This feature may also be used for medical record cards and the like where additional patient specific information may be stored.

The credit/financial information 54 is the most sensitive and will be specially encoded and protected from unauthorized upload to the particular TIST 22. It is envisioned that access to this information will be specifically triggered by the consumer using corresponding input. For example, if a consumer wishes to pay for purchases using a VISA card, a button on the consumer input 24 may be activated which allows access to credit/financial info 54 corresponding to VISA cards. If multiple such accounts are stored on the UCIM 47, a selection screen would be presented to allow the consumer to determine which VISA card was intended. Alternatively, the user pay have a specific PIN or the like corresponding to each account and may enter this to permit the TIST 22 to access the corresponding information.

For enhanced security and privacy, the UCIM 47 may be set such that it cannot be automatically activated and will be intensely personal to the particular consumer. Personal security protection 56 is provided to minimize the potential that the UCIM 47 could be stolen and used by another. One preferred form of personal security 56 is the use of a particular PIN 58 (Personal Identification Number) which the consumer must enter in order to unlock access to the UCIM 47 at all. A password is the alphanumeric equivalent of a PIN 58 and may be used in the same way if the interface is sufficiently sophisticated. Another preferred method would be a thumbprint reader 60 built into the PMD 34. The thumbprint reader 60 is keyed specifically to the personal owner of the PMD 34 and only the application of the correct thumbprint subsequent to insertion of the PMD 34 into the dataport 30 will “unlock” access to the contents of the PMD 34.

The thumbprint reader 60 discussed above is only one type of biological identifier device 62 which may be utilized to guarantee personal security. Other existing technology which could be used include fingerprint readers, voice print comparators, retinal scan comparators and readers of embedded code circuits in the user's body (RFI ID devices). Future technology will no doubt include DNA scanners capable of analyzing and matching a particular user's DNA from a touch or a breath sample.

The biological identifier device 62 may be part of the UCIM 47 or may be part of the TIST 22 or other part of the institutional subsystem 12. There are advantages to having the biological identifier device 62 be part of the UCIM 47 in that access to the information in the UCIM 47 is controlled completely by the user on a local basis. This facilitates use of the UCIM 47 remotely, such as over wireless or internet type connections, thus greatly expanding the types of transaction which may be handled using the system 10. For other purposes, such as reduced manufacturing costs for the UCIM 47, the biological indemnification device 82 may be part of the institutional subsystem 12. Further, if flexibility for sharing use with a trusted friend or family member is important, it may be desirable to use the previously discussed PIN or password identification methods.

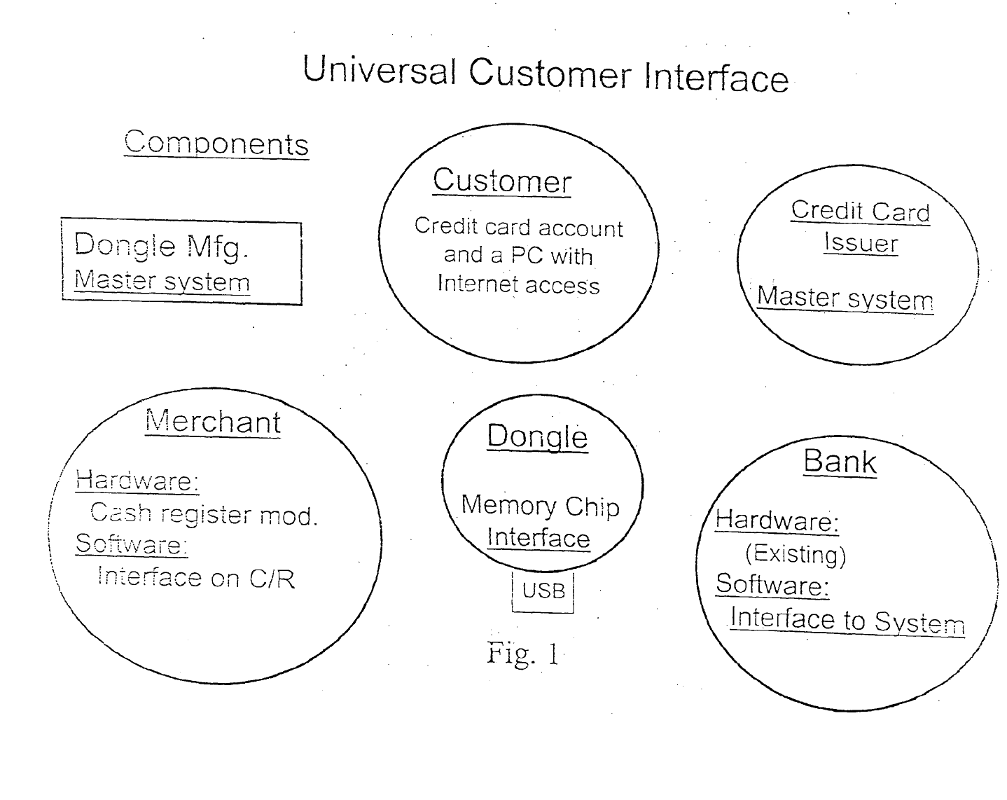

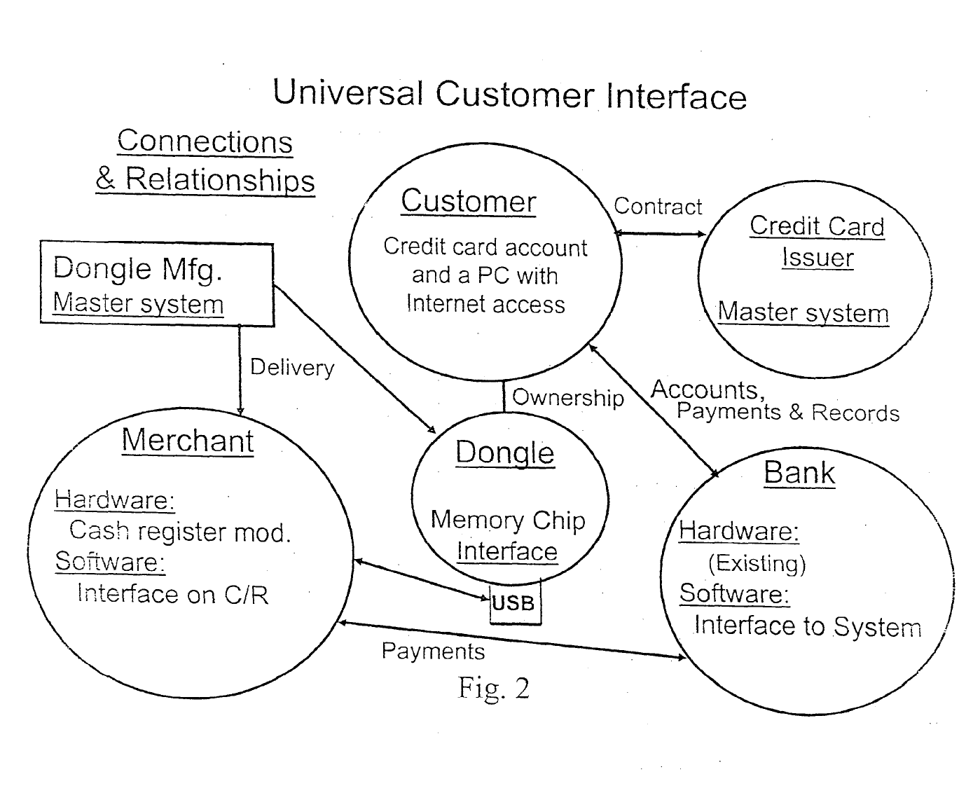

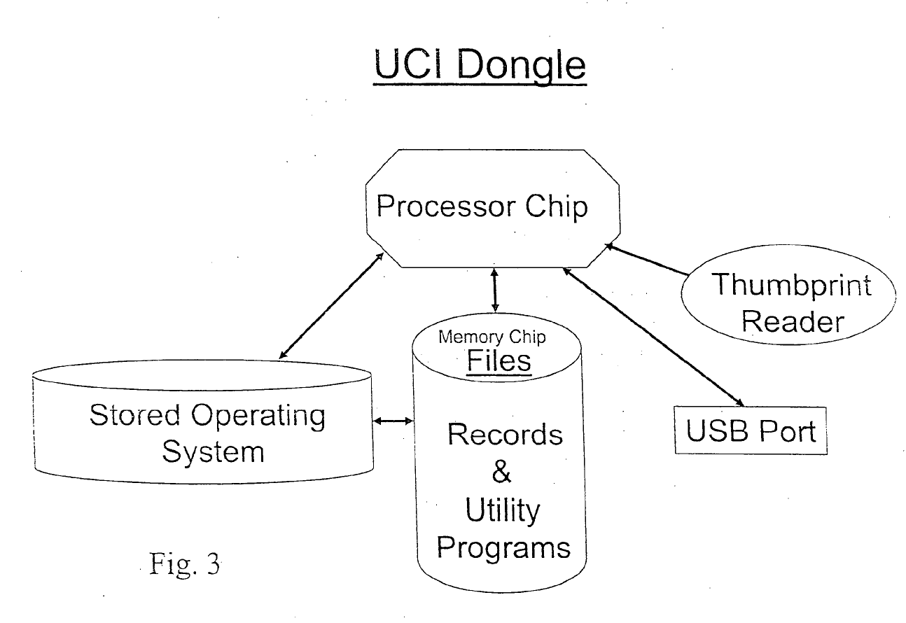

One envisioned commercial application of the system 10 involves the use of the Issuer Specific Interface Module (ISIM) 55. This special embodiment in referred to as the Universal Customer Interface 64 and is illustrated in the several figures of the drawing. FIG. 1 Shows the Universal Customer Interface 64 in terms of its various components. FIG. 2. illustrates the connections and relationships among the components and FIG. 3 shows the aspects of the preferred UCIM 47 (referred to as a “dongle”) utilized in this embodiment.

Three (in some ways four) of the components illustrated in FIG. 1 are common to all of the embodiments of the present invention. The Customer (user) 66 is a necessary element of the invention since it is the user who must be involved to create any of the transactions 11 envisioned. Similarly an institution 68 (either the Merchant 70 or the Bank 72 of FIG. 1) is necessary to interact with the User 66 in any transaction 11, be it a purchase (merchant 70) or a financial transaction affecting an account (Bank 72). In addition, a dongle 74 is part of all embodiments, whether it is simple PMD 34, and more complex UCIM 47 or a self authenticating ISIM 55 as required for the Universal Customer Interface embodiment 64.

The deluxe dongle 74 of FIG. 1 is intended to be self-authenticating by carrying all of the critical information in its memory component 76 (usually a chip) and its logic component 78 (often a separate chip). The dongle 74 has an interface component 80 (presently embodied as a USB interface) which allows the dongle 74 to interface whether directly with the institutional subsystem 12 when present at an institutional facility with a corresponding dataport or with a personal computer (PC) 82 or equivalent device (internet enabled cellular devices or Bluetooth devices, for example) having a compatible dataport for remote transactions, such as over the internet where the user 66 and institution 68 are spatially separated. It is particularly desirable for remote transactions for the dongle to be self-authenticating so that the triggering/activation does not require any involvement of the institutional subsystem 12 and none of the sensitive identification information ever reaches the institutional records. By accomplishing this, the security problems related to transmitting sensitive data in readable form are minimized or eliminated. With a self-authenticating dongle 74 transactions 11 can be accomplished without the need of the institution 68 ever “knowing” the user's credit card number, expiration date or code, for example. It is noted that in long distance (internet) transactions, paper receipts 28 are rarely concurrently generated. For these purposes, there is no printer interrupt 36 function required, unlike the case with point of sale or ATM transactions.

When the Universal Customer Interface 64 is utilized to engage in a credit transaction the Credit Card Issuer (Issuer) 84 becomes directly involved. Rather than having the institution 68 separately query the Issuer 84, a direct connection is created between the dongle 74 and the Issuer 84. The Issuer's system will recognize the input from the dongle and will, provided the dongle 74 has been unlocked (authenticated) by the user, will automatically recognize the specific user 66 as genuine and will process the transaction (assuming, of course, that a viable credit relationship obtains). In the event that a direct account withdrawal is desired from the user's bank to supply funds to an institution, the same sort of interaction will occur, with the Bank 72 filling the slot of the Issuer 84.

In order to be self authenticating, the dongle 74 must be provided with hardware and/or software to recognize user-unique authentication. Only when this is provided will the dongle 74 (via the logic component 78) unlock the sensitive information 54 contained in the memory component 76 so that remote or institutional access is permitted to such. The preferred approach to self-authentication is to provide a biological identifier device 62 as described above built into the dongle 74. This will allow unlocking only when the actual user 66 physically (or sonically) interacts with the dongle after the dongle has been plugged into (or otherwise interfaced) with the dataport. A less-preferred authentication may be accomplished by using a PIN 58 or password activation which can be input into the dongle 74 from a keypad associated with the PC 82 at which the user is physically present (either at a transaction-remote location, such as the user's home or at the TIST 22 for direct transactions). In either event, the special construction of the dongle 74 requires the involvement of a Dongle Manufacturer 86 to create the specially equipped dongle 74.

The connections and relationships among the components, illustrated in FIG. 2, are discussed in more detail below in the Industrial Applicability section.

The components of the UCI Dongle 74 are illustrated in FIG. 3. The interface component 80 is illustrated in this figure as a USB port. The memory component 76 is illustrated as a memory chip which stores the records created by the user 66 and the issuer 84 plus any ETR records 38 created during use. The types of data stored on the memory component will typically include Personal ID information 50, vendor member information 52 and credit/financial information 54 as well as encryption keys, and the biological identification device 62 pattern (biometric data) to be matched in order to activate the two way communication. The memory component 76 will also store the utility programs necessary to the various functions. The logic component 78 is illustrated as including a processor chip and a stored operating system, as well as the utility programs stored on the memory component 76. In the embodiment illustrated, the biological identifier device 62 is a thumbprint reader 60.

It is envisioned that particular Credit Card Issuers 84 and/or Banks 72 may wish to incentivize the use of the inventive system 10 and instill particular customer loyalty in their own credit programs by issuing the Issuer Specific Interface Module (ISIM) 55 to customers. The ISIM 55 will be provided to a customer already preprogrammed with the personal credit financial information 54 specific to the user's account with the Issuer 84 and with utility programs specifically adapted to operate in conjunction with the Issuer's TIST 22. The ISIM will be likely to be emblazoned with the trademarks and logos of the Issuer 84. The ISIM 55 may or may not be adapted to permit storage of vendor member information 52 for vendors other than the issuer 84.

Numerous other variants and modifications of the paperless transaction trail system 10 of the present invention may be envisioned and implemented. The above discussed embodiments are for exemplary purposes only and the appended claims are to be interpreted as encompassing the true and full spirit and scope of the invention.

While various embodiments have been described above, it should be understood that they have been presented by way of example only, and not limitation.

### INDUSTRIAL APPLICABILITY

The paperless transaction trail system 10 of the present invention is intended for use by consumers and institutions as an electronic means of recording transactions. Full implementation will require efforts by both groups, but such will result in highly significant savings in paper and printing materials and will drastically reduce the amount of waste contributed to the environment as a result of transactions.

A typical institution, for example the XYZ Grocery chain, implements the system 10 by installing a TIST 22 module into their cash register system, also providing a dataport 30 (USB port 32) accessible to the consumer at each station. Nothing prevents the cash register transaction from operating as before when the dataport 30 is not activated, but, when a consumer, such as Ms. Jane Doe, inserts a PMD 34 into the dataport 30 and activates access by inserting her PIN 58 or applying her thumbprint to the reader 60, multiple benefits automatically ensue.

Initially, the printer 26 is disabled for the transaction by the printer interrupt 36, although this may be overridden manually if desired. Next, the TIST 22 accesses the corresponding encoded vendor membership information 54 and recognizes that Jane Doe is a member of the XYZ Preferred Buyer's Club and is entitled to discounts on some items purchased. This allows the TIST 22 to recalculate pricing on the affected items and concurrently present the correct charges on the virtual receipt. At the time that payment is required Ms. Doe provides manual input to the consumer input structure 24 to select payment by VISA, which allows the TIST 22 to access the VISA information 54 on the PMD 34 and perform the customary credit check electronically with the issuing institution.

At the close of the transaction 11, the TIST downloads an ETR 38 to the PMD 34, with the ETR 38 including an institutional ID 40 and Date and Time coding 44 specific to the transaction 11. Further each item purchased will have a transaction item entry 44 in the ETR 38 which will adequately identify the item (e.g. a jar of pickles) as well as the price. In this case, the TIST 22 will also update Jane Doe's membership information 52 in the XYZ Club by updating the running tally of purchases made, indicating that she is eligible for a larger discount on the next transaction 11. Ms. Does disengages her PMD 34 from the dataport 30 and leaves with only her purchases, unburdened by a wasteful ½ meter long receipt.

Later in the day, Ms. Doe realizes that she purchased the wrong type of pickles and returns to XYZ in order to return or exchange the item. Jane Doe again plugs her PMD 34 into the dataport 30 and the ETR 38 is accessed by the TIST 22 (which can immediately recognize the Institutional ID 40 and date and time coding 42 corresponding to the particular transaction 11. The prior purchase is clearly acknowledged and the revised transaction is easily accomplished, with Jane Doe leaving XYZ quickly and happily.

At a time of her choosing, Jane Doe then connects her PMD 34 to her own personal computer and downloads the relevant ETRs 38 into her accounting program, which processes the information. In this case, Ms. Doe is entitled to a specific tax deduction for pickles and the transactions are duly noted for inclusion on her tax return. All is accomplished without paper.

The inventor refers to the Consumer subsystem 14 as a SHUBOX™ since it replaces the physical shoe box into which paper receipts and the like are typically stored for sorting and use when accounting is required. Since the SHUBOX 14 is convenient and easily storable, it saves a great deal of hassle for the user. The PMD 34 contents can be duplicated onto personal computer memory and, if needed, onto another PMD to protect against catastrophic events such as memory failure.

In the case of the Universal Customer Interface embodiment 64 the initial impetus is likely to come from the credit Issuer 84. The Issuer 84 will commission the manufacture of customized dongles 74 (emblazoned with Issuer's logo) from the Dongle Manufacturer 86. These are then provided with Issuer specific programming in logic component 78 for facilitating easy recognition and interface with the Issuer's TIST 22. The customized dongles 74 are then apportioned out to users 66 (either new customers of Issuer 84 or existing credit card holders). When apportioned to the User 66 the customized dongle 74 will already be provided with the customers specific account information and other identification information already in the Issuer's files. The User 66 will then activate the dongle 74 and provide the security input to facilitate unlocking the two way communication mode. For full security, it may be that this initial activation may take place at an Issuer monitored location or it may be performed by the user at the user's PC 82, with appropriate security safeguards such as password or security question input to open the dongle 74 for programming. In the embodiment discussed above, the dongle 74 is readied by the software and the user will place a thumb on the thumbprint reader 60 in order to record a reference pattern for comparison. This biological identifier is saved in the memory component and locked in “permanently”. In this manner the dongle 74 is completely personalized to the user and can only be used by the particular person to whom it has been issued.

When the customer 66 engages in a point of sale transaction the dongle 74 functions as discussed above for most purposes. However, when it comes time for payment, the customer 66 will activate the dongle 74 by applying a thumbprint to the thumbprint reader 60 which will trigger the credit transaction. The TIST 22 associated with the merchant 70 will recognize the coded signal generated by the dongle and will initiate direct communication with the institutional subsystem 12 of the Issuer 84, which instantly recognizes the encrypted signal form the dongle 74 as identifying the authenticated user 66 and the account and contemporaneously authorizes the payment to the Merchant 70. This authorization and payment is accomplished without the Merchant's system ever having access to any of the credit/financial account information 54 or personal identification information 50 of the User 66. This credit transaction takes place with approximately equal or better speed than those of conventional debit card transactions, but with a much greater degree of security, since only the activated User 66 can use his or her dongle 74. The dongle 74 also records each transaction 11 with an ETR 38 stored in memory for later use, as discussed above.

When the User 66 wishes to undertake a remote transaction (such as over the internet) the dongle 74 is inserted into the USB dataport on the user's own PC 82 (or a similar device at which the User 66 is physically present. The transaction is activated when the User 66 applies the thumbprint when the dongle 74 is powered (through the USB connection). This unlocks the communication and facilitates sending the encrypted authorization to the Issuer 84. As the only sensitive information Credit/Financial information 54 transmitted over the internet is the encrypted signal recognized by the Issuer, this transaction is much more secure as the internet Merchant 70 or service provider (such as an online role playing or gaming site) does not receive any of this information, only the authorization from the Issuer 84. Data errors involved in entering information are also prevented. Thus the transaction is more convenient, accurate and secure than present technology.

The convenience, positive environmental impact, and security advantages of the present invention are of great benefit to the consumer. Similarly, the printing material savings, electronic form of transaction data and convenience of transactions are of great benefit to the institutions.

For the above, and other, reasons, it is expected that the paperless transaction system 10 of the present invention will have widespread industrial applicability. Therefore, it is expected that the commercial utility of the present invention will be extensive and long lasting.

What is claimed is:

1. A paperless transaction system for use in transactions between an institution and a consumer, comprising:
an institutional subsystem having a processing unit and at a consumer accessible dataport; and
a consumer subsystem including a user-carried memory device dongle personal to the particular consumer, said dongle being adapted to interface with said dataport; wherein
transaction data specific to the transaction is downloaded to said dongle through said dataport, as an alternative to a printed transaction record.

2. The paperless transaction system of claim 1, wherein
said consumer accessible dataport is a USB port.

3. The paperless transaction system of claim 1, wherein said consumer accessible dataport is a wireless interface adapted to recognize and exchange data with said dongle.

4. The paperless transaction system of claim 1, wherein
said transaction data includes an encrypted transaction number assigned to the particular transaction, said encrypted transaction number also being associated with transaction records maintained by said institutional subsystem.

5. The paperless transaction system of claim 1,
engagement of said dongle with said consumer accessible dataport triggers a printer interrupt to prevent printing of physical transaction records and directs transaction records in electronic form to said dongle.

6. The paperless transaction system of claim 1,
said dongle is made user-specific so it will only operate with a particular user by embedding personal security triggering therein, said personal security triggering permitting access to information stored in said dongle only when the user provides a user-specific identification trigger during said transaction which matches said embedded personal security triggering.

7. The paperless transaction system of claim 6,
said user-specific identification trigger is selected from the group comprising: user-provided data input in the form of a personal identification number input by said user; user-provided data input in the form of a password input by said user; and a biological identifier specific to said user; and further wherein
said biological identifier is selected from the group comprising: fingerprint, thumbprint, voice recognition pattern, voice command, retinal scan, embedded RFID matching and DNA sampling.

8. A consumer interface system for two way communication between a consumer and a vendor/institution, comprising
a vendor/institution subsystem including at least one transaction information supply terminal (TIST) having a data processor programmed with operational software and a interface port accessible to the consumer; and
a universal consumer interface module (USIM) adapted to be personally carried by the consumer, said USIM including a physical dongle having a memory component, a logic component and a port component compatible with said interface port;
wherein engaging said port component with said interface port initiates a transaction mode between said USIM and said TIST.

9. The consumer interface system of claim 8, wherein the initiation of said transaction mode disables physical print components associated with said TIST such that no concurrent physical record of said transaction is generated.

10. The consumer interface system of claim 8, wherein
said memory component is preprogrammed with user specific data which said logic component delivers to said TIST when said transaction mode is initiated; and
said data processor programming associates said user specific data with existing records of said vendor/institution and activates any user-specific transaction modifiers which apply to the particular user.

11. The consumer interface system of claim 8, wherein
said USIM is specific to a particular credit issuer;
said memory component includes data specific to the user's account with said credit issuer; and
said logic component interacts with said TIST to invoke a credit transaction specific to said user and said credit issuer.

12. The consumer interface system of claim 11, and further including
a user-specific security identification trigger unique to said user such that only said user may activate said transaction mode between said USIM and said TIST.

13. The consumer interface system of claim 12, wherein
said user-specific identification trigger is a personal identification number input by said user.

14. The consumer interface system of claim 12, wherein
said user-specific identification trigger is a biological identifier specific to said user.

15. The consumer interface system of claim 13, wherein
said biological identifier is selected from the group comprising fingerprint, thumbprint, voice recognition pattern, voice command, retinal scan, embedded RFID matching and DNA sampling.

16. A system for providing a transaction interface between an institution in the form of a vendor, service provider or credit provider and a consumer entity, comprising:
an institutional computing and data subsystem provided by the institution to control and record a transaction, said institutional subsystem being partially accessible by the consumer entity; and
a consumer subsystem personal to the consumer entity for accessing said institutional subsystem and interchanging data during said transaction, said consumer subsystem including a physical dongle having a memory component, a logic computing component and an interface component.

17. The system for providing a transaction interface of claim 16, wherein
the accessibility of said institutional subsystem is accomplished over a remote network; and
the consumer entity engages said interface component of said dongle with a consumer-entity-controlled electronic communications device accessing said remote network.

18. The system for providing a transaction interface of claim 16, wherein
the accessibility of said institutional subsystem is accomplished by a point-of-transaction dataport; and
the consumer entity engages said interface component of said dongle by placing said dongle into interface position with said point-of-transaction dataport.

19. The system for providing a transaction interface of claim 16, wherein
said dongle provides access between said institutional subsystem and said memory component only after being provided with an unlocking trigger by the consumer entity; said unlocking trigger being selected from the group comprising: PIN number, password, fingerprint, thumbprint, voice recognition pattern, voice command, retinal scan, embedded RFID matching and DNA sampling.

20. The system for providing a transaction interface of claim 16, wherein
said dongle memory component includes consumer entity specific credit information which may be utilized by said institutional subsystem to trigger a credit transaction without further information provided by the consumer entity.
